(19) United States
(12) Patent Application Publication
(10) Pub. No.: US 2018/0351812 A1
(43) Pub. Date: Dec. 6, 2018

(54) TECHNOLOGIES FOR DYNAMIC BANDWIDTH MANAGEMENT OF INTERCONNECT FABRIC

(71) Applicant: Intel Corporation, Santa Clara, CA (US)

(72) Inventors: Eric R. Borch, Fort Collins, CO (US); Robert C. Zak, Bolton, MA (US); Mario Flajslik, Hudson, MA (US); Jonathan M. Eastep, Portland, OR (US); Michael A. Parker, Santa Clara, CA (US)

(21) Appl. No.: 15/941,918

(22) Filed: Mar. 30, 2018

Related U.S. Application Data
(60) Provisional application No. 62/514,611, filed on Jun. 2, 2017.

(51) Int. Cl. H04L 12/24; H04L 12/26

(52) U.S. Cl. CPC H04L 41/0896; H04L 43/0882

(57) ABSTRACT

Technologies for dynamic bandwidth management of interconnect fabric include a compute device configured to calculate a predicted fabric bandwidth demand which is expected to be used by the interconnect fabric in a next epoch and subsequent to a present epoch. The compute device is additionally configured to determine whether any global links and/or local links of the interconnect fabric can be disabled during the next epoch as a function of the calculated predicted fabric bandwidth demand and a number of redundant paths associated with the links of the interconnect fabric. The compute device is further configured to disable one or more of the global links and/or the local links that can be disabled, the one or more local links of the plurality of local links that can be disabled. Other embodiments are described herein.

### CROSS-REFERENCE TO RELATED APPLICATIONS

The present application claims priority under 35 U.S.C. § 119(e) to U.S. Provisional Patent Application Serial No. 62/514,611, entitled “DYNAMIC BANDWIDTH MANAGEMENT OF INTERCONNECT FABRIC,” which was filed on Jun. 2, 2017.

### STATEMENT REGARDING FEDERALLY SPONSORED RESEARCH

This invention was made with Government support under contract number H98230A-13-D-0124-026 awarded by the Department of Defense. The Government has certain rights in this invention.

### BACKGROUND

Modern computing devices have become ubiquitous tools for personal, business, and social uses. As such, many modern computing devices are capable of connecting to various data networks, including the Internet, to transmit and receive data communications over the various data networks at varying rates of speed. To facilitate communications to/from endpoint computing devices, the data networks typically include one or more network computing devices (e.g., compute servers, storage servers, etc.) to route communications (e.g., via switches, routers, etc.) that enter/exit a network (e.g., north-south network traffic) and between network computing devices in the network (e.g., east-west network traffic). Demands by individuals, researchers, and enterprises (e.g., network operators and service providers) for increased compute performance and storage capacity of network computing devices have resulted in various computing technologies developed to address those demands.

For example, compute intensive and/or latency sensitive applications, such as enterprise cloud-based applications (e.g., software as a service (SaaS) applications), data mining applications, data-driven modeling applications, scientific computation problem solving applications, etc., can benefit from being processed on specialized, high-performance computing (HPC) devices typically found in complex, large-scale computing environments (e.g., HPC environments, cloud computing environments, etc.). Such large-scale computing environments can include tens of hundreds to hundreds of thousands of multi-processor/multi-core network computing devices connected via high-speed, low-level interconnects. The high-speed interconnects in HPC environments typically include Ethernet-based interconnects, such as 100 Gigabit Ethernet (100 GigE) interconnects, or HPC system optimized interconnects (i.e., supporting very high throughput and very low latency), such as InfiniBand or Intel® Omni-Path interconnects. However, in large HPC systems, a significant amount of power to the network is dedicated to enabling such high bandwidth interconnects to handle network bound applications. Additionally, many presently employed technologies are such that the interconnects consume power whether they are utilized or idle, resulting in wasted power consumption.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a high-performance computing (HPC) network for dynamic bandwidth management of interconnect fabric that includes multiple interconnected compute nodes communicatively coupled to a fabric management compute device;

FIG. 2 is a simplified block diagram of at least one embodiment of one of the compute nodes of the system of FIG. 1;

FIG. 3 is a simplified block diagram of at least one embodiment of the fabric management compute device of the system of FIG. 1;

FIG. 4 is a block diagram of at least one embodiment of an environment that may be established by the fabric management compute device of the system of FIG. 1;

FIG. 5 is a simplified flow diagram of at least one embodiment of a method for dynamic bandwidth management of interconnect fabric that may be executed by the fabric management compute device of FIGS. 1, 3, and 4;

FIG. 6 is a simplified block diagram of at least one embodiment of a series of interconnected groups that each includes multiple local node switches, global switches, and the compute nodes of the system of FIG. 1 in a two-level hierarchical interconnect HPC network topology; and

FIGS. 7A-7D are simplified block diagrams of at least one embodiment of one of the groups of the two-level hierarchical interconnect HPC network topology of FIG. 6 in which at least a portion of the interconnect fabric is disabled.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

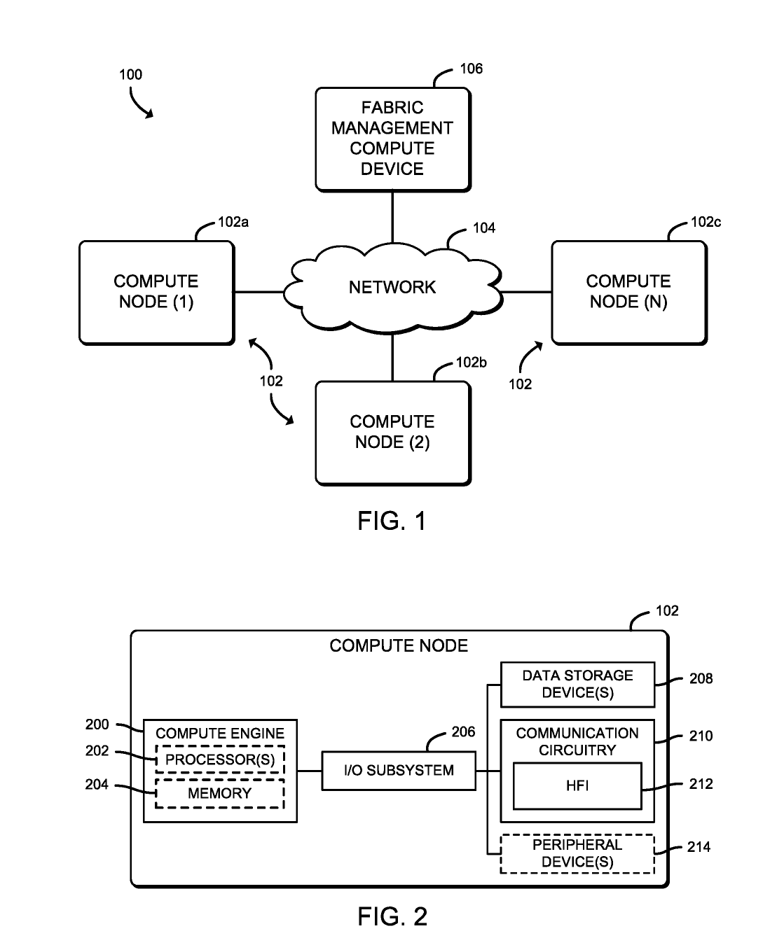

Referring now to FIG. 1, a system 100 includes multiple compute devices 102, each of which are communicatively coupled, via a network 104, to at least one other computing node 102 in the network 104. The network 104 may be embodied as any type of network capable of communicatively connecting the compute devices 102, such as a high performance computing (HPC) system, a data center, etc. Accordingly, the network 104 may be established through a series of links/interconnects (i.e., high-bandwidth links/interconnects), switches, routers, and other network devices which are capable of connecting the various compute nodes 102 of the network 104.

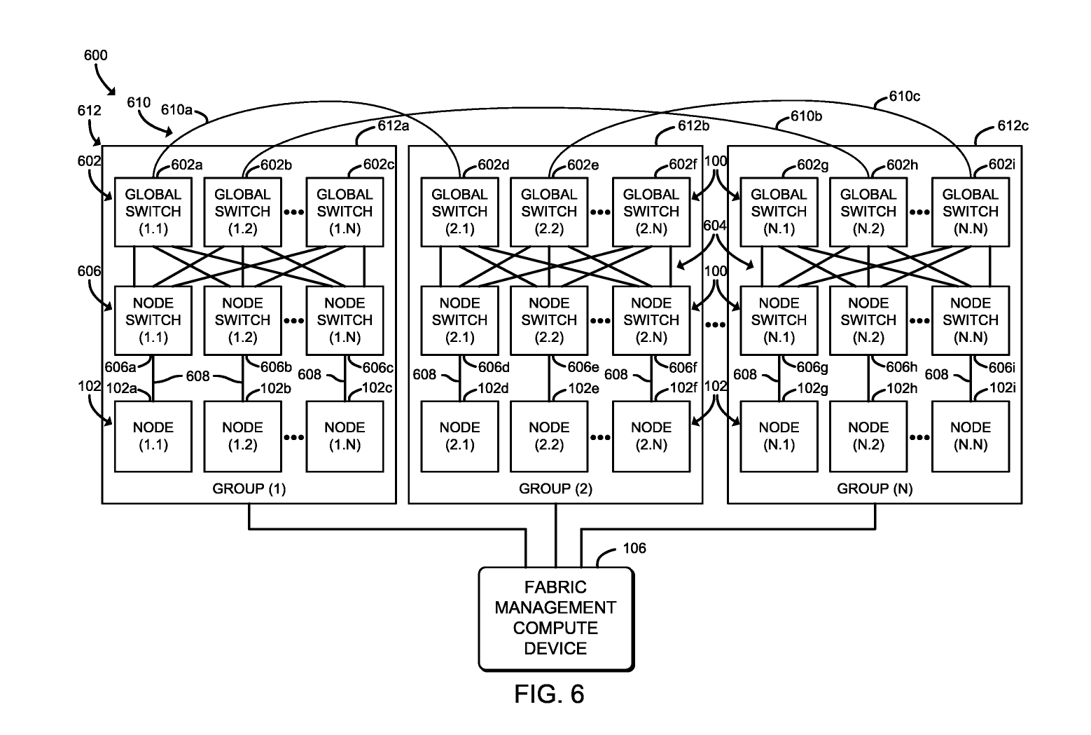

As will be described in further detail below (see, e.g., FIG. 6), the compute nodes 102 form a scalable hierarchical interconnect topology that includes multiple groups, each of which includes at least two levels of network switches (e.g., local node switches and global switches) that are interconnected in a topological arrangement. Each group of global switches is globally connected to the global switches of the other groups in an all-to-all fashion (i.e., the groups form a clique globally). To do so, one or more of the global switches in one group are connected via global links, or global interconnects, to one or more global switches of the other groups. Each group additionally includes multiple compute nodes 102, each of which are communicatively coupled via node links, or node interconnects, to a respective one of the local node switches. Additionally, each of the local node switches are communicatively coupled via local links, or local interconnects, to each of the global switches of the group to which each of the local node switches corresponds.

The illustrative system 100 additionally includes a fabric management compute device 106. In use, as will be described in further detail below, the fabric management compute device 106 is configured to reduce power consumed by the links by only leaving those links (i.e., local links and global links) and global switches enabled that are along paths which are required to process/forward network traffic through the system 100 over a given period of time, or epoch. It should be appreciated that multiple paths (e.g., minimal or non-minimal) may exist for any given network traffic received into the system 100. Accordingly, it should be further appreciated that such multiple paths can be redundant, and, as such, not all such redundant paths are required to remain available to effectively process/forward network traffic through the system 100 over a given period of time.

To determine which links (i.e., local links and global links) and global switches are to be enabled (i.e., powered on) and which links and global switches can be disabled (i.e., powered down, not remaining idle), the fabric management compute device 106 is configured to predict a total amount of bandwidth that is expected to be used (i.e., a predicted fabric bandwidth demand) over a period of time in the future (e.g., based on jobs presently in a job queue). Based on the predicted fabric bandwidth demand, the fabric management compute device 106 can determine those links and global switches which are required to be enabled to facilitate the expected bandwidth associated with predicted fabric bandwidth demand, and effectively disable the other links and, if applicable, one or more global switches. It should be appreciated that other factors may influence the determination, such as quality of service (QoS) requirements, minimal path policies, etc.

Each of the compute nodes 102 may be embodied as any type of compute device capable of performing the functions described herein, including, but not limited to, a compute device, a storage device, a server (e.g., stand-alone, rack-mounted, blade, etc.), a sled (e.g., a compute sled, an accelerator sled, a storage sled, etc.), an enhanced network interface controller (NIC) (e.g., a host fabric interface (HFI)), a network appliance (e.g., physical or virtual), a router, a web appliance, a distributed computing system, a processor-based system, and/or a multiprocessor system. Referring now to FIG. 2, an illustrative one of the compute nodes 102 is shown which includes a compute engine 200, an 110 subsystem 206, one or more data storage devices 208, communication circuitry 210, and, in some embodiments, one or more peripheral devices 214. It should be appreciated that the compute node 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 200 may be embodied as any type of device or collection of devices capable of performing the various compute functions as described herein. In some embodiments, the compute engine 200 may be embodied as a single device, such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein. Additionally, in some embodiments, the compute engine 200 may include, or may be embodied as, one or more processors 202 (i.e., one or more central processing units (CPUs)) and memory 204.

The processor(s) 202 may be embodied as any type of processor capable of performing the functions described herein. For example, the processor(s) 202 may be embodied as one or more single-core processors, one or more multi-core processors, a digital signal processor, a microcontroller, or other processor or processing/controlling circuit(s). In some embodiments, the processor(s) 202 may be embodied as, include, or otherwise be coupled to a field programmable gate array (FPGA), an application specific integrated circuit (ASIC), reconfigurable hardware or hardware circuitry, or other specialized hardware to facilitate performance of the functions described herein.

The memory 204 may be embodied as any type of volatile (e.g., dynamic random access memory (DRAM), etc.) or non-volatile memory or data storage capable of performing the functions described herein. It should be appreciated that the memory 204 may include main memory (i.e., a primary memory) and/or cache memory (i.e., memory that can be accessed more quickly than the main memory). Volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 200 is communicatively coupled to other components of the compute node 102 via the I/O subsystem 206, which may be embodied as circuitry and/or components to facilitate input/output operations with the processor 202, the memory 204, and other components of the compute node 102. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with the compute engine 200 (e.g., the processor 202, the memory 204, etc.) and/or other components of the compute node 102, on a single integrated circuit chip.

The one or more data storage devices 208 may be embodied as any type of storage device(s) configured for short-term or long-term storage of data, such as, for example, memory devices and circuits, memory cards, hard disk drives, solid-state drives, or other data storage devices. Each data storage device 208 may include a system partition that stores data and firmware code for the data storage device 208. Each data storage device 208 may also include an operating system partition that stores data files and executables for an operating system.

The communication circuitry 210 may be embodied as any communication circuit, device, or collection thereof, capable of enabling communications between the compute node 102 and other computing devices, such as the fabric management compute device 106, the illustrative switches 602, 606 of FIG. 6, etc., as well as any network communication enabling devices, such as a gateway, an access point, other network switches/routers, etc., to allow ingress/egress of network traffic. Accordingly, the communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

It should be appreciated that, in some embodiments, the communication circuitry 210 may include specialized circuitry, hardware, or combination thereof to perform pipeline logic (e.g., hardware algorithms) for performing the functions described herein, including processing network packets (e.g., parse received network packets, determine destination computing devices for each received network packets, forward the network packets to a particular buffer queue of a respective host buffer of the compute node 102, etc.), performing computational functions, etc.

In some embodiments, performance of one or more of the functions of communication circuitry 210 as described herein may be performed by specialized circuitry, hardware, or combination thereof of the communication circuitry 210, which may be embodied as a system-on-a-chip (SoC) or otherwise form a portion of a SoC of the compute node 102 (e.g., incorporated on a single integrated circuit chip along with a processor 202, the memory 204, and/or other components of the compute node 102). Alternatively, in some embodiments, the specialized circuitry, hardware, or combination thereof may be embodied as one or more discrete processing units of the compute node 102, each of which may be capable of performing one or more of the functions described herein.

The illustrative communication circuitry 210 includes an HFI 212. The HFI 212 may be embodied as one or more add-in-boards, daughtercards, network interface cards, controller chips, chipsets, or other devices that may be used by the compute node 102 to connect with another compute device (e.g., the endpoint computing device 102). In some embodiments, the HFI 212 may be embodied as part of a system-on-a-chip (SoC) that includes one or more processors, or included on a multichip package that also contains one or more processors. In some embodiments, the HFI 212 may include a local processor (not shown) and/or a local memory (not shown) that are both local to the HFI 212. In such embodiments, the local processor of the HFI 212 may be capable of performing one or more of the functions of a processor 202 described herein. Additionally or alternatively, in such embodiments, the local memory of the HFI 212 may be integrated into one or more components of the compute node 102 at the board level, socket level, chip level, and/or other levels.

The one or more peripheral devices 214 may include any type of device that is usable to input information into the compute node 102 and/or receive information from the compute node 102. The peripheral devices 214 may be embodied as any auxiliary device usable to input information into the compute node 102, such as a keyboard, a mouse, a microphone, a barcode reader, an image scanner, etc., or output information from the compute node 102, such as a display, a speaker, graphics circuitry, a printer, a projector, etc. It should be appreciated that, in some embodiments, one or more of the peripheral devices 214 may function as both an input device and an output device (e.g., a touchscreen display, a digitizer on top of a display screen, etc.). It should be further appreciated that the types of peripheral devices 214 connected to the compute node 102 may depend on, for example, the type and/or intended use of the compute node 102. Additionally or alternatively, in some embodiments, the peripheral devices 214 may include one or more ports, such as a USB port, for example, for connecting external peripheral devices to the compute node 102.

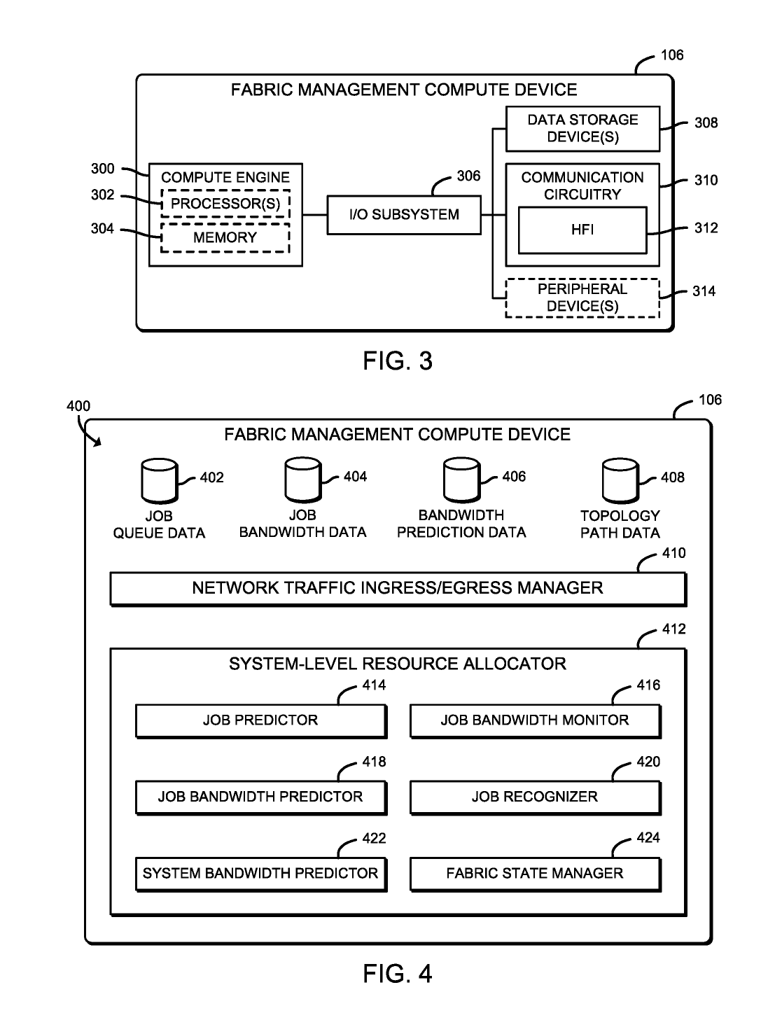

Referring back to FIG. 1, the fabric management compute device 106 may be embodied as any type of computation or computing device capable of performing the functions described herein, including, without limitation, a server (e.g., stand-alone, rack-mounted, blade, etc.), a sled (e.g., a compute sled, an accelerator sled, a storage sled, a memory sled, etc.), an enhanced NIC (e.g., an HFI)), a network appliance (e.g., physical or virtual), a router, switch (e.g., a disaggregated switch, a rack-mounted switch, a standalone switch, a fully managed switch, a partially managed switch, a full-duplex switch, and/or a half-duplex communication mode enabled switch), a web appliance, a distributed computing system, a processor-based system, and/or a multiprocessor system. Referring now to FIG. 3, as illustratively shown, the fabric management compute device 106 includes similar and/or like components to those of the illustrative compute node 102 of FIG. 2, including a compute engine 300 with one or more processors 302 and memory 304, an I/O subsystem 306, one or more data storage devices 308, communication circuitry 310 with an HFI 312, and, in some embodiments, one or more peripheral devices 314. As such, figures and descriptions of the similar/like components are not repeated herein for clarity of the description with the understanding that the description of the corresponding components provided above in regard to the compute node 102 of FIG. 2 applies equally to the corresponding components of the fabric management compute device 106 of FIG. 3. Of course, it should be appreciated that the respective computing devices may include additional and/or alternative components, depending on the embodiment.

Referring now to FIG. 4, in use, the fabric management compute device 106 establishes an illustrative environment 400 during operation. The illustrative environment 400 includes a network traffic ingress/egress manager 410 and a system-level resource allocator 412. The various components of the environment 400 may be embodied as hardware, firmware, software, or a combination thereof. As such, in some embodiments, one or more of the components of the environment 400 may be embodied as circuitry or collection of electrical devices (e.g., network traffic ingress/egress management circuitry 410, system-level resource allocation circuitry 412, etc.).

It should be appreciated that, in such embodiments, one or both of the network traffic ingress/egress management circuitry 410 and the system-level resource allocation circuitry 412 may form a portion of one or more of the compute engine 300, the I/O subsystem 306, the communication circuitry 310, and/or other components of the fabric management compute device 106. Additionally, in some embodiments, one or more of the illustrative components may form a portion of another component and/or one or more of the illustrative components may be independent of one another. Further, in some embodiments, one or more of the components of the environment 400 may be embodied as virtualized hardware components or emulated architecture, which may be established and maintained by the compute engine 300 or other components of the fabric management compute device 106. It should be appreciated that the fabric management compute device 106 may include other components, sub-components, modules, sub-modules, logic, sub-logic, and/or devices commonly found in a computing device, which are not illustrated in FIG. 4 for clarity of the description.

In the illustrative environment 400, the fabric management compute device 106 additionally includes job queue data 402, job bandwidth data 404, bandwidth prediction data 406, and topology path data 408, each of which may be accessed by the various components and/or sub-components of the fabric management compute device 106. Additionally, it should be appreciated that in some embodiments the data stored in, or otherwise represented by, each of the job queue data 402, the job bandwidth data 404, the bandwidth prediction data 406, and the topology path data 408 may not be mutually exclusive relative to each other. For example, in some implementations, data stored in the job bandwidth data 404 may also be stored as a portion of one or more of the job queue data 402 and/or the bandwidth prediction data 406. As such, although the various data utilized by the fabric management compute device 106 is described herein as particular discrete data, such data may be combined, aggregated, and/or otherwise form portions of a single or multiple data sets, including duplicative copies, in other embodiments.

The network traffic ingress/egress manager 410, which may be embodied as hardware, firmware, software, virtualized hardware, emulated architecture, and/or a combination thereof as discussed above, is configured to receive inbound and route/transmit outbound network traffic. To do so, the network traffic ingress/egress manager 410 is configured to facilitate inbound/outbound network communications (e.g., network traffic, network packets, network flows, etc.) to and from the fabric management compute device 106. For example, the network traffic ingress/egress manager 410 is configured to manage (e.g., create, modify, delete, etc.) connections to physical and virtual network ports (i.e., virtual network interfaces) of the fabric management compute device 106 (e.g., via the HFI 312 of the communication circuitry 310), as well as the ingress/egress buffers/queues associated therewith. In some embodiments, at least a portion of the payload of the received network communications (e.g., operation requests, payload/header data, etc.) may be stored in the job queue data 402.

The system-level resource allocator 412, which may be embodied as hardware, firmware, software, virtualized hardware, emulated architecture, and/or a combination thereof as discussed above, is configured to reduce overall power consumption of the system in which the fabric management compute device 106 is responsible for managing, by only leaving those links (i.e., local links and global links) and global switches of the system enabled that are along paths that are required to process/forward network traffic through the system 100 over a given period of time, or epoch. To do so, the illustrative system-level resource allocator 412 includes a job predictor 414, a job bandwidth monitor 416, a job bandwidth predictor 418, a job recognizer 420, a system bandwidth predictor 422, and a fabric state manager 424. It should be appreciated that such components of the illustrative system-level resource allocator 412 may similarly be embodied as hardware, firmware, software, or a combination thereof. As such, in some embodiments, one or more of the components of the illustrative system-level resource allocator 412 may be embodied as circuitry or collection of electrical devices (e.g., job prediction circuitry 414, job bandwidth monitoring circuitry 416, job bandwidth prediction circuitry 418, job recognition circuitry 420, system bandwidth prediction circuitry 422, fabric state management circuitry 424, etc.).

The job predictor 414 is configured to predict which jobs are to be performed over a certain predefined window of time (i.e., an “epoch”) in the future. To do so, the job predictor 414 is configured to monitor a job queue and identify which of those jobs presently in the job queue are to be performed over the next epoch (i.e., subsequent to the present epoch having elapsed). Accordingly, the job predictor 414 is configured to query or otherwise receive data associated with the jobs in the job queue. Such information may be stored, in some embodiments, in the job queue data 402. The job bandwidth monitor 416 is configured to monitor bandwidth usage of past jobs (e.g., during the present epoch, during a previous epoch, etc.) and store the results of the monitored bandwidth usage (e.g., in the job bandwidth data 404).

The job bandwidth predictor 418 is configured to predict a total amount of bandwidth expected to be used (i.e., a predicted fabric bandwidth demand) over the next epoch for each job in the queue that is expected to be executed based at least in part on the stored results of the monitored bandwidth usage corresponding to the jobs presently in the job queue which have been predicted to run in the next epoch. To do so, the job bandwidth predictor 418 may be configured to determine which jobs of a job queue are to be run in the next epoch and determine, for each of those jobs, a per-job predicted bandwidth demand. Accordingly, the job bandwidth predictor 418 may be configured to calculate the predicted fabric bandwidth demand as a sum of the per-job predicted bandwidth demand. The per-job bandwidth prediction results may be stored in the bandwidth prediction data 406, in some embodiments.

The job recognizer 420 is configured to employ a hashing of a binary executable to generate a unique identifier for each job. The job recognizer 420 may be further configured to examine properties of each job. The job properties may include any information usable to identify a job, the operation(s) to be performed thereon, and/or the resources required to perform the operation(s), including, but not limited to, an input data size, a requested compute node count, etc. It should be appreciated that such job properties may be used (e.g., by the job bandwidth predictor 418) to determine bandwidth usage predictions as a function thereof. In some embodiments, the job properties may be stored in the job queue data 402.

The system bandwidth predictor 422 is configured to predict an expected total system bandwidth usage of the next epoch. To do so, the system bandwidth predictor 422 may be configured to determine the predicted fabric bandwidth demand as a function of an exponential moving average of past bandwidth usage/demand (i.e., associated with bandwidth used for previous jobs) on a per-job basis and aggregates the results into a total system bandwidth prediction. Additionally or alternatively, the job bandwidth predictor 418 may be configured to determine the predicted fabric bandwidth demand as a function of presently queued jobs in the job queue which will run over the next epoch relative to historical bandwidth usage of like or similar jobs performed previously (e.g., based at least in part on the per-job bandwidth prediction results as determined by the job bandwidth predictor 418). The bandwidth predictions and associated information (e.g., the predicted fabric bandwidth demand, the exponential moving average of past bandwidth usage/demand, etc.) may be stored in the bandwidth prediction data 406, in some embodiments.

The fabric state manager 424 is configured to identify which of the links (i.e., local links and global links) and global switches are to be enabled/disabled for the next epoch. To do so, the fabric state manager 424 is configured to identify which paths are resources required to accommodate the predicted fabric bandwidth demand over that epoch. The fabric state manager 424 is additionally configured to identify which links are redundant and may be disabled, while still accommodating the predicted fabric bandwidth demand over that epoch. In some embodiments, the fabric state manager 424 may be configured to apply one or more policy rules, such as may be based on a minimal path policy, a QoS policy (e.g., such as may be job or epoch specific), etc., to determine which links associated with the corresponding paths are to be enabled/disabled.

Depending on the embodiment of the fabric management compute device 106 and the network in which the system-level resource allocator 412 is deployed, it should be appreciated that the system-level resource allocator 412 may be an extension of existing control-plane hardware and/or software of any computing device which is capable of controlling resources of the network fabric and associated hardware (e.g., the compute nodes 102, switches, routers, etc.), such as a network controller, a software defined network (SDN) controller, a network functions virtualization (NFV) manager and network orchestrator (MANO), etc.

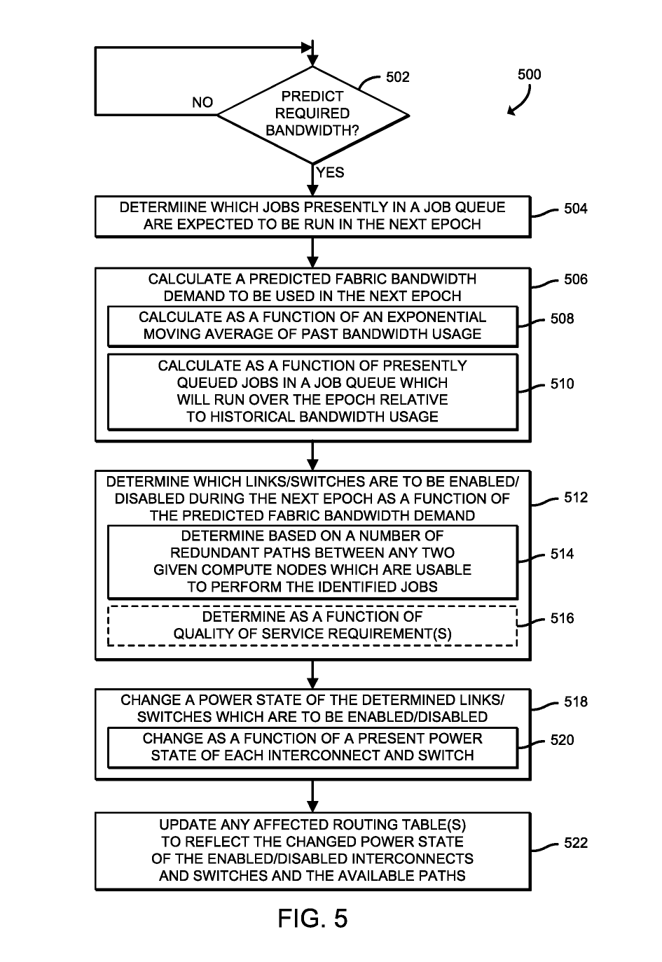

Referring now to FIG. 5, a method 500 for dynamic bandwidth management of interconnect fabric is shown which may be executed by a computing device (e.g., the fabric management compute device 106 of FIGS. 1 and 4) capable of controlling whether resources (e.g., links, switches, routers, etc.) of the interconnect fabric are enabled or disabled. The method 500 begins with block 502, in which the fabric management compute device 106 determines whether a required bandwidth is to be calculated (i.e., for an upcoming window of time, or epoch). If so, the method 500 advances to block 504, in which the fabric management compute device 106 is configured to determine which jobs presently in a job queue (i.e., of jobs to be run) are expected to be run in the next epoch.

In block 506, the fabric management compute device 106 calculates a predicted fabric bandwidth demand (i.e., a total amount of bandwidth which is expected to be used over the next epoch). In other words, the fabric management compute device 106 is configured to predict based on jobs presently in the job queue that have been identified as those which are expected to be run in the next epoch. For example, in block 508, the fabric management compute device 106 may calculate an exponential moving average as a function of past bandwidth demand of the jobs run in one or more previous epochs and/or the present epoch, and use the exponential moving average to calculate the predicted fabric bandwidth demand. In another example, in block 510, the fabric management compute device 106 may calculate the predicted fabric bandwidth demand to be used as a function of historical bandwidth usage associated with the identified jobs expected to be run in the next epoch. To do so, the fabric management compute device 106 may determine which jobs presently enqueued in a job queue are to be nm in the next epoch, determine a predicted bandwidth demand for each of those jobs, and calculate the predicted fabric bandwidth demand as a calculated sum of the per-job predicted bandwidth demand.

In block 512, the fabric management compute device 106 determines which network fabric resources (i.e., local links/interconnects, global links/interconnects, global switches, etc.) are to be enabled/disabled during the next epoch as a function of the predicted fabric bandwidth demand. To do so, in block 514, the fabric management compute device 106 may determine a number of redundant paths between any two given compute nodes 102 that are usable to provide a path between compute devices that are capable of performing a particular one or more of the identified jobs. Accordingly, the fabric management compute device 106 is additionally configured to disable those links/switches which are considered to be redundant. In other words, not all such redundant paths are required to remain available to effectively process/forward network traffic through the next epoch and, as such, one or more of the links and/or global switches thereon may be disabled. Additionally or alternatively, in some embodiments, in block 516, the fabric management compute device 106 may rely on one or more QoS requirements to make the determination as to which links and switches of the network fabric are to be enabled/disabled.

In block 518, the fabric management compute device 106 changes a power state (i.e., enabled/powered on or disabled/powered off) which is consistent with the determined links and global switches which are to be enabled/disabled during the next epoch. It should be appreciated that the power state adjustments will be made in a timely fashion and in time to meet the predicted fabric bandwidth demand of the next epoch without interrupting or otherwise interfering with the previously determined power state for any presently executing epoch. Additionally, in block 520, the power state of each determined link/switch to be enabled/disabled will be changed as a function of a present power state of each determined link/switch to be enabled/disabled. In other words, a presently enabled or disabled link or switch will only have their power state altered if the present power state differs from the determined power state for that link or switch. In block 522, the fabric management compute device 106 updates any one or more affected routing tables to reflect the available paths relative to the changed power state(s) of any links/switches from one epoch to the next.

Referring now to FIG. 6, an illustrative series of interconnected groups 612 is shown, each of which are communicatively coupled to a fabric management compute device 106. The illustrative interconnected group 612 includes a first group, which is designated as group (1) 612a, a second group, which is designated as group (2) 612b, and a third group, which is designated as group (N) 612c (i.e., the “Nth” group of the interconnected groups 612, wherein “N” is a positive integer that designates one or more additional groups 612). Each of the groups 612 includes multiple global switches 602. The illustrative global switches 602 of group (1) include a first global switch, which is designated as global switch (1.1) 602a, a second global switch, which is designated as global switch (1.2) 602b, and a third global switch, which is designated as global switch (1.N) 602c (i.e., the “Nth” global switch of the global switches 602 of the first group 612a, wherein “N” is a positive integer that designates one or more additional global switches 602). Similarly, group (2) 612b includes global switches 602d, 602e, and 602f, while group (N) 612c includes global switches 602g, 602h, and 602i. Each of the global switches 602 may be connected to each global switch 602 of the other groups 612 via global links 610 (e.g., the global links 610a, 610b, and 610c). It should be appreciated that, while only one global switch 602 from each group 612 is illustratively shown as being coupled to another global switch 602 in another group 612, in other embodiments one or more of the global switches 602 from each group 612 may be communicatively coupled to more than one of the global switches 602 of the other groups 612.

Each of the global switches 602 in each group 612 are communicatively coupled to each of the local node switches 606 of the same group 612 via local links 604. As illustratively shown, the local node switches 606 of group (1) include a first local node switch, which is designated as node switch (1.1) 606a, a second local node switch, which is designated as node switch (1.2) 606b, and a third local node switch, which is designated as node switch (1.N) 606c (i.e., the “Nth” local node switch of the local node switches 602 of the first group 612a, wherein “N” is a positive integer that designates one or more additional local node switches 606). Similarly, group (2) 612b includes local node switches 606d, 606e, and 606f, while group (N) 612c includes local node switches 606g, 606h, and 606i.

Each of the local node switches 606 of each group 612 are communicatively coupled to a respective compute node 102 via a node link 608. As illustratively shown, the compute nodes 102 of group (1) include a first compute node, which is designated as node (1.1) 102a, a second compute node, which is designated as node (1.2) 102b, and a third compute node, which is designated as node (1.N) 102c (i.e., the “Nth” compute node of the compute nodes 102 of the first group 612a, wherein “N” is a positive integer that designates one or more additional compute nodes 102). Similarly, group (2) 612b includes compute nodes 102d, 102e, and 102f, while group (N) 612c includes compute nodes 102g, 102h, 102i. It should be appreciated that, while illustratively shown as a one-to-one connection between compute nodes 102 and local node switches 606, multiple compute nodes 102 may be connected to the local node switches 606, in other embodiments.

The fabric management compute device 106 is illustratively shown as being communicatively coupled to each interconnected group 612. For example, in some embodiments, the fabric management compute device 106 may be communicatively coupled to each group 612 via one or more computing devices (e.g., a router), which are not shown for clarity of the description, but are capable of functioning as a group resource controller (i.e., to enable/disable the local links 604, the global links 610, the global switches 602, etc.). Additionally, while the network topology of FIG. 6 is illustratively shown as having two levels of network switches (e.g., local node switches 606 and global switches 602) interconnected in a topological arrangement, it should be appreciated that fewer or additional levels of network switches and/or routers may be present in alternative network embodiments. For example, unlike the illustrative groups 612 of FIG. 6, the topological arrangement may be in a single tier arrangement of switches within each group 612 that are coupled via local links 604 to each of the compute nodes 102, and the switches are communicatively coupled between the various groups 612 via global links 610.

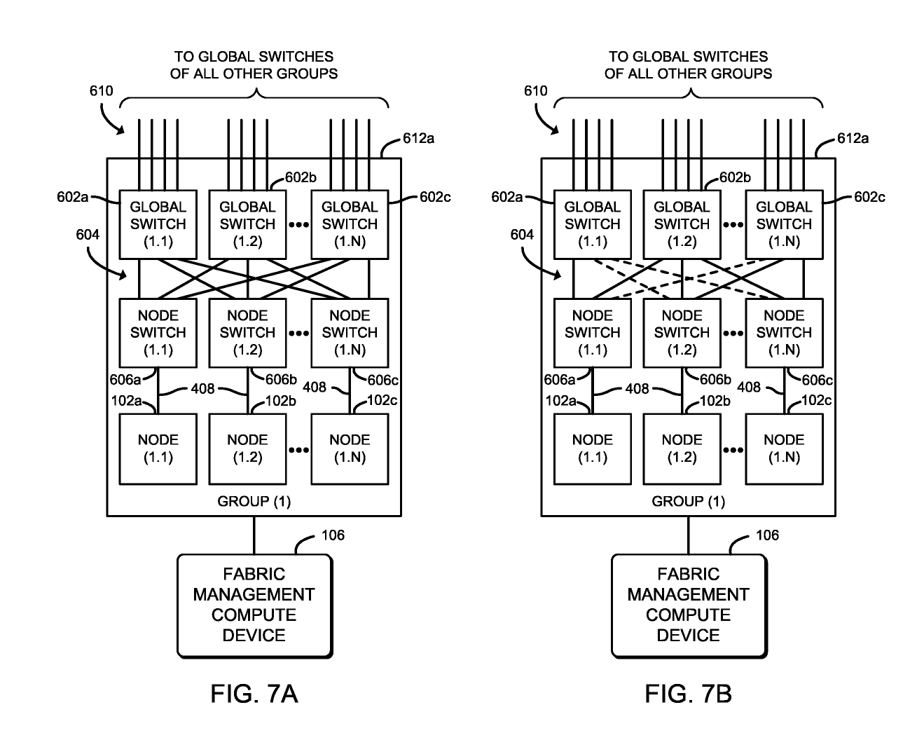

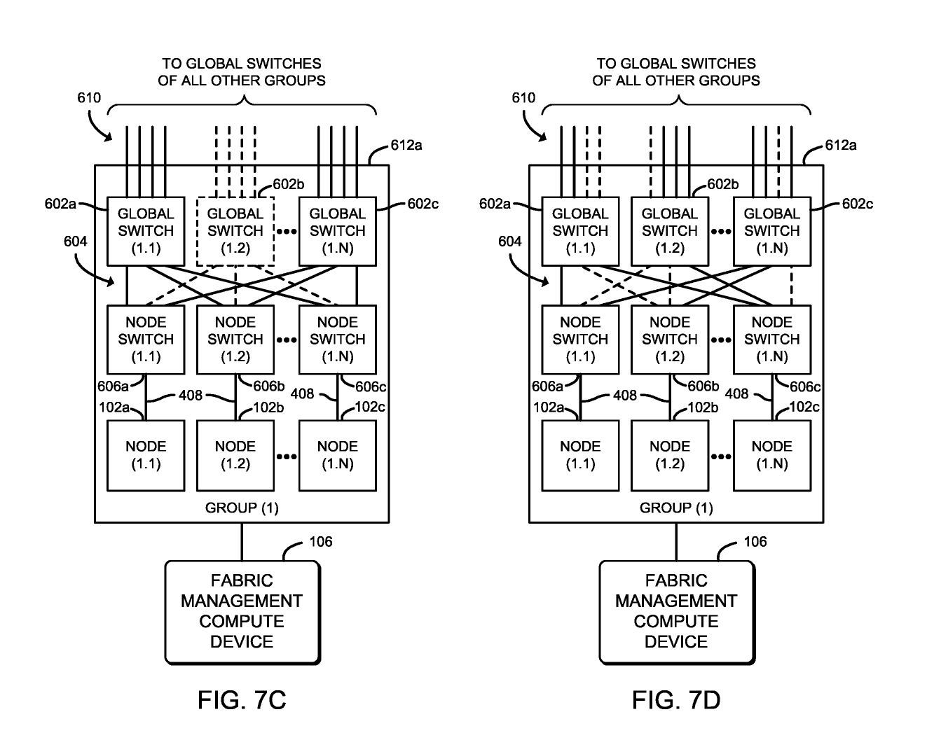

Referring now to FIGS. 7A-7D, the illustrative group (1) 612a of the two-level hierarchical interconnect HPC network topology of FIG. 6 is shown through which at least a portion of the interconnect fabric is disabled. In FIG. 7A, the group (1) 612a, as previously described above in regard to FIG. 6, is illustratively shown in its initial state prior to the disabling of any portions of the interconnect fabric. In FIG. 7B, the group (1) 612a is illustratively shown wherein at least a portion of the local links 604 have been disabled (i.e., powered off). Accordingly, it should be appreciated that the fabric management compute device 106 has determined that the local links 604 between the node switch (1.1) 606a and the global switch (1.N) 602c, the node switch (1.2) 606b and the global switch (1.1) 602a, and the node switch (1.N) 606c and the global switch (1.1) 602a are to be disabled (e.g., as described above in the method 500 of FIG. 5). In FIG. 7C, the group (1) 612a is illustratively shown wherein the global switch (1.2) 602b has been disabled. Accordingly, the local links 604 and the global links 610 coupled thereto are also disabled. In FIG. 7D, the group (1) is illustratively shown wherein a portion of the global links 610 and a portion of the local links 604 have been disabled.

While each of the local links 604 and global links 610 are described herein as being powered off, it should be appreciated that, in some embodiments, at least a portion of the unused links 604, 610 may be idled rather than powered off. For example, one or more of the expected to be unused links 604, 610 along a particular path (e.g., a redundant path) may be idled and can be used as a backup mechanism in the event the redundant path is determined to be necessary (e.g., due to a fault or other error along the other path) during a given epoch. As such, it should be further appreciated that power consumption of the idled links and powered off links is not as power-efficient as merely powering off the unused links 604, 610.

### EXAMPLES

Illustrative examples of the devices, systems, and methods disclosed herein are provided below. An embodiment of the devices, systems, and methods may include any one or more, and any combination of, the examples described below.

Example 1 includes a compute device for dynamic bandwidth management of an interconnect fabric that includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links, the compute device comprising a processor; a memory having stored thereon a plurality of instructions that, when executed, cause the compute device to calculate a predicted fabric bandwidth demand which is expected to be used by the interconnect fabric in a next epoch and subsequent to a present epoch; determine whether any one or more global links of the plurality of global links can be disabled during the next epoch as a function of the calculated predicted fabric bandwidth demand; determine whether any local links of the plurality of local links can be disabled during the next epoch as a function of the calculated predicted fabric bandwidth demand; disable, in response to a determination that one or more global links of the plurality of global links can be disabled, the one or more global links of the plurality of global links that can be disabled; and disable, in response to a determination that one or more local links of the plurality of local links can be disabled, the one or more local links of the plurality of local links that can be disabled.

Example 2 includes the subject matter of Example 1, and wherein to calculate the predicted fabric bandwidth demand comprises to determine a set of jobs in a job queue that are to be run in the next epoch and subsequent to the present epoch, wherein the job queue includes a plurality of enqueued jobs; determine a predicted bandwidth demand for each of the set of enqueued jobs; and calculate the predicted fabric bandwidth demand as a function of a sum of the predicted bandwidth demand for each job.

Example 3 includes the subject matter of any of Examples 1 and 2, and wherein to calculate the predicted fabric bandwidth demand comprises to calculate the predicted fabric bandwidth demand as an exponential moving average based on past fabric bandwidth usage over one or more previous epochs.

Example 4 includes the subject matter of any of Examples 1-3, and wherein to determine whether any global links of the plurality of global links can be disabled during the next epoch comprises to determine a set of jobs in a job queue that are to be run in the next epoch and subsequent to the present epoch, wherein the job queue includes a plurality of enqueued jobs; determine one or more possible paths between a first compute node in a first group and a second compute node in a second group for each of the set of jobs in the job queue; determine which of the one or more possible paths can be unused in the next epoch and still satisfy the predicted fabric bandwidth demand; and determine whether each of the global links of the plurality of global links can be disabled as a function of whether that global link is in the one or more possible paths which can be unused.

Example 5 includes the subject matter of any of Examples 1-4, and wherein to determine whether any local links of the plurality of local links can be disabled during the next epoch comprises to determine a set of jobs in a job queue that are to be run in the next epoch and subsequent to the present epoch, wherein the job queue includes a plurality of enqueued jobs; determine one or more possible paths between one compute node in a first group and another compute node in a second group for each of the set of jobs in the job queue; determine which of the one or more possible paths can be unused in the next epoch and still satisfy the predicted fabric bandwidth demand; and determine whether each of the local links of the plurality of local links can be disabled as a function of whether that local link is in the one or more possible paths which can be unused.

Example 6 includes the subject matter of any of Examples 1-5, and wherein to determine whether any of the one or more global links of the plurality of global links can be disabled during the next epoch comprises to determine whether any of the one or more global links of the plurality of global links can be disabled during the next epoch based on one or more quality of service requirements.

Example 7 includes the subject matter of any of Examples 1-6, and wherein to determine whether any of the one or more local links of the plurality of local links can be disabled during the next epoch comprises to determine whether any of the one or more local links of the plurality of local links can be disabled during the next epoch based on one or more quality of service requirements.

Example 8 includes the subject matter of any of Examples 1-7, and wherein the plurality of instructions further cause the compute device to determine whether any global switches of the plurality of global switches can be disabled during the next epoch as a function of the calculated predicted fabric bandwidth demand and the determined any global links of the plurality of global links which can be disabled during the next epoch.

Example 9 includes the subject matter of any of Examples 1-8, and wherein the plurality of instructions further cause the compute device to update one or more routing tables to reflect the disabled one or more global links of the plurality of global links and the disabled one or more local links of the plurality of local links.

Example 10 includes one or more machine-readable storage media comprising a plurality of instructions stored thereon that, in response to being executed, cause a compute device to calculate a predicted fabric bandwidth demand which is expected to be used by the interconnect fabric in a next epoch and subsequent to a present epoch, wherein the interconnect fabric includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links; determine whether any one or more global links of the plurality of global links can be disabled during the next epoch as a function of the calculated predicted fabric bandwidth demand; determine whether any local links of the plurality of local links can be disabled during the next epoch as a function of the calculated predicted fabric bandwidth demand; disable, in response to a determination that one or more global links of the plurality of global links can be disabled, the one or more global links of the plurality of global links that can be disabled; and disable, in response to a determination that one or more local links of the plurality of local links can be disabled, the one or more local links of the plurality of local links that can be disabled.

Example 11 includes the subject matter of Example 10, and wherein to calculate the predicted fabric bandwidth demand comprises to determine a set of jobs in a job queue that arc to be run in the next epoch and subsequent to the present epoch, wherein the job queue includes a plurality of enqueued jobs; determine a predicted bandwidth demand for each of the set of enqueued jobs; and calculate the predicted fabric bandwidth demand as a function of a sum of the predicted bandwidth demand for each job.

Example 12 includes the subject matter of any of Examples 10 and 11, and wherein to calculate the predicted fabric bandwidth demand comprises to calculate the predicted fabric bandwidth demand as an exponential moving average based on past fabric bandwidth usage over one or more previous epochs.

Example 13 includes the subject matter of any of Examples 10-12, and wherein to determine whether any global links of the plurality of global links can be disabled during the next epoch comprises to determine a set of jobs in a job queue that are to be run in the next epoch and subsequent to the present epoch, wherein the job queue includes a plurality of enqueued jobs; determine one or more possible paths between a first compute node in a first group and a second compute node in a second group for each of the set of jobs in the job queue; determine which of the one or more possible paths can be unused in the next epoch and still satisfy the predicted fabric bandwidth demand; and determine whether each of the global links of the plurality of global links can be disabled as a function of whether that global link is in the one or more possible paths which can be unused.

Example 14 includes the subject matter of any of Examples 10-13, and wherein to determine whether any local links of the plurality of local links can be disabled during the next epoch comprises to determine a set of jobs in a job queue that are to be run in the next epoch and subsequent to the present epoch, wherein the job queue includes a plurality of enqueued jobs; determine one or more possible paths between one compute node in a first group and another compute node in a second group for each of the set of jobs in the job queue; determine which of the one or more possible paths can be unused in the next epoch and still satisfy the predicted fabric bandwidth demand; and determine whether each of the local links of the plurality of local links can be disabled as a function of whether that local link is in the one or more possible paths which can be unused.

Example 15 includes the subject matter of any of Examples 10-14, and wherein to determine whether any of the one or more global links of the plurality of global links can be disabled during the next epoch comprises to determine whether any of the one or more global links of the plurality of global links can be disabled during the next epoch based on one or more quality of service requirements.

Example 16 includes the subject matter of any of Examples 10-15, and wherein to determine whether any of the one or more local links of the plurality of local links can be disabled during the next epoch comprises to determine whether any of the one or more local links of the plurality of local links can be disabled during the next epoch based on one or more quality of service requirements.

Example 17 includes the subject matter of any of Examples 10-16, and wherein the plurality of instructions further cause the compute device to determine whether any global switches of the plurality of global switches can be disabled during the next epoch as a function of the calculated predicted fabric bandwidth demand and the determined any global links of the plurality of global links which can be disabled during the next epoch.

Example 18 includes the subject matter of any of Examples 10-17, and wherein the plurality of instructions further cause the compute device to update one or more routing tables to reflect the disabled one or more global links of the plurality of global links and the disabled one or more local links of the plurality of local links.

Example 19 includes a compute device for dynamic bandwidth management of an interconnect fabric that includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links, the compute device comprising means for calculating a predicted fabric bandwidth demand which is expected to be used by the interconnect fabric in a next epoch and subsequent to a present epoch; means for determining whether any one or more global links of the plurality of global links can be disabled during the next epoch as a function of the calculated predicted fabric bandwidth demand; means for determining whether any local links of the plurality of local links can be disabled during the next epoch as a function of the calculated predicted fabric bandwidth demand; circuitry for disabling, in response to a determination that one or more global links of the plurality of global links can be disabled, the one or more global links of the plurality of global links that can be disabled; and circuitry for disabling, in response to a determination that one or more local links of the plurality of local links can be disabled, the one or more local links of the plurality of local links that can be disabled.

Example 20 includes the subject matter of Example 19, and wherein the means for calculating the predicted fabric bandwidth demand comprises means for determining a set of jobs in a job queue that are to be run in the next epoch and subsequent to the present epoch, wherein the job queue includes a plurality of enqueued jobs; means for determining a predicted bandwidth demand for each of the set of enqueued jobs; and means for calculating the predicted fabric bandwidth demand as a function of a sum of the predicted bandwidth demand for each job.

Example 21 includes the subject matter of any of Examples 19 and 20, and wherein the means for calculating the predicted fabric bandwidth demand comprises means for calculating the predicted fabric bandwidth demand as an exponential moving average based on past fabric bandwidth usage over one or more previous epochs.

Example 22 includes the subject matter of any of Examples 19-21, and wherein the means for determining whether any global links of the plurality of global links can be disabled during the next epoch comprises means for determining a set of jobs in a job queue that are to be run in the next epoch and subsequent to the present epoch, wherein the job queue includes a plurality of enqueued jobs; means for determining one or more possible paths between a first compute node in a first group and a second compute node in a second group for each of the set of jobs in the job queue; means for determining which of the one or more possible paths can be unused in the next epoch and still satisfy the predicted fabric bandwidth demand; and means for determining whether each of the global links of the plurality of global links can be disabled as a function of whether that global link is in the one or more possible paths which can be unused.

Example 23 includes the subject matter of any of Examples 19-22, and wherein the means for determining whether any local links of the plurality of local links can be disabled during the next epoch comprises means for determining a set of jobs in a job queue that are to be run in the next epoch and subsequent to the present epoch, wherein the job queue includes a plurality of enqueued jobs; means for determining one or more possible paths between one compute node in a first group and another compute node in a second group for each of the set of jobs in the job queue; means for determining which of the one or more possible paths can be unused in the next epoch and still satisfy the predicted fabric bandwidth demand; and means for determining whether each of the local links of the plurality of local links can be disabled as a function of whether that local link is in the one or more possible paths which can be unused.

Example 24 includes the subject matter of any of Examples 19-23, and wherein the compute device further comprises means for determining whether any global switches of the plurality of global switches can be disabled during the next epoch as a function of the calculated predicted fabric bandwidth demand and the determined any global links of the plurality of global links which can be disabled during the next epoch.

Example 25 includes the subject matter of any of Examples 19-24, and wherein the compute device further comprises means for updating one or more routing tables to reflect the disabled one or more global links of the plurality of global links and the disabled one or more local links of the plurality of local links.

1. A compute device for dynamic bandwidth management of an interconnect fabric that includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links, the compute device comprising:
a processor;
a memory having stored thereon a plurality of instructions that, when executed, cause the compute device to:
calculate a predicted fabric bandwidth demand which is expected to be used by the interconnect fabric in a next epoch and subsequent to a present epoch;
determine whether any one or more global links of the plurality of global links can be disabled during the next epoch as a function of the calculated predicted fabric bandwidth demand;
determine whether any local links of the plurality of local links can be disabled during the next epoch as a function of the calculated predicted fabric bandwidth demand;
disable, in response to a determination that one or more global links of the plurality of global links can be disabled, the one or more global links of the plurality of global links that can be disabled; and
disable, in response to a determination that one or more local links of the plurality of local links can be disabled, the one or more local links of the plurality of local links that can be disabled.

2. The compute device of claim 1, wherein to calculate the predicted fabric bandwidth demand comprises to:
determine a set of jobs in a job queue that are to be run in the next epoch and subsequent to the present epoch, wherein the job queue includes a plurality of enqueued jobs;
determine a predicted bandwidth demand for each of the set of enqueued jobs; and
calculate the predicted fabric bandwidth demand as a function of a sum of the predicted bandwidth demand for each job.

3. The compute device of claim 1, wherein to calculate the predicted fabric bandwidth demand comprises to calculate the predicted fabric bandwidth demand as an exponential moving average based on past fabric bandwidth usage over one or more previous epochs.

4. The compute device of claim 1, wherein to determine whether any global links of the plurality of global links can be disabled during the next epoch comprises to:
determine a set of jobs in a job queue that are to be run in the next epoch and subsequent to the present epoch, wherein the job queue includes a plurality of enqueued jobs;
determine one or more possible paths between a first compute node in a first group and a second compute node in a second group for each of the set of jobs in the job queue;
determine which of the one or more possible paths can be unused in the next epoch and still satisfy the predicted fabric bandwidth demand; and
determine whether each of the global links of the plurality of global links can be disabled as a function of whether that global link is in the one or more possible paths which can be unused.

5. The compute device of claim 1, wherein to determine whether any local links of the plurality of local links can be disabled during the next epoch comprises to:
determine a set of jobs in a job queue that are to be run in the next epoch and subsequent to the present epoch, wherein the job queue includes a plurality of enqueued jobs;
determine one or more possible paths between one compute node in a first group and another compute node in a second group for each of the set of jobs in the job queue;
determine which of the one or more possible paths can be unused in the next epoch and still satisfy the predicted fabric bandwidth demand; and
determine whether each of the local links of the plurality of local links can be disabled as a function of whether that local link is in the one or more possible paths which can be unused.

6. The compute device of claim 1, wherein to determine whether any of the one or more global links of the plurality of global links can be disabled during the next epoch comprises to determine whether any of the one or more global links of the plurality of global links can be disabled during the next epoch based on one or more quality of service requirements.

7. The compute device of claim 1, wherein to determine whether any of the one or more local links of the plurality of local links can be disabled during the next epoch comprises to determine whether any of the one or more local links of the plurality of local links can be disabled during the next epoch based on one or more quality of service requirements.

8. The compute device of claim 1, wherein the plurality of instructions further cause the compute device to determine whether any global switches of the plurality of global switches can be disabled during the next epoch as a function of the calculated predicted fabric bandwidth demand and the determined any global links of the plurality of global links which can be disabled during the next epoch.

9. The compute device of claim 1, wherein the plurality of instructions further cause the compute device to update one or more routing tables to reflect the disabled one or more global links of the plurality of global links and the disabled one or more local links of the plurality of local links.

10. One or more machine-readable storage media comprising a plurality of instructions stored thereon that, in response to being executed, cause a compute device to:
calculate a predicted fabric bandwidth demand which is expected to be used by the interconnect fabric in a next epoch and subsequent to a present epoch, wherein the interconnect fabric includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links;
determine whether any one or more global links of the plurality of global links can be disabled during the next epoch as a function of the calculated predicted fabric bandwidth demand;
determine whether any local links of the plurality of local links can be disabled during the next epoch as a function of the calculated predicted fabric bandwidth demand;
disable, in response to a determination that one or more global links of the plurality of global links can be disabled, the one or more global links of the plurality of global links that can be disabled; and
disable, in response to a determination that one or more local links of the plurality of local links can be disabled, the one or more local links of the plurality of local links that can be disabled.

11. The one or more machine-readable storage media of claim 10, wherein to calculate the predicted fabric bandwidth demand comprises to:
determine a set of jobs in a job queue that are to be run in the next epoch and subsequent to the present epoch, wherein the job queue includes a plurality of enqueued jobs;
determine a predicted bandwidth demand for each of the set of enqueued jobs; and
calculate the predicted fabric bandwidth demand as a function of a sum of the predicted bandwidth demand for each job.

12. The one or more machine-readable storage media of claim 10, wherein to calculate the predicted fabric bandwidth demand comprises to calculate the predicted fabric bandwidth demand as an exponential moving average based on past fabric bandwidth usage over one or more previous epochs.

13. The one or more machine-readable storage media of claim 10, wherein to determine whether any global links of the plurality of global links can be disabled during the next epoch comprises to:
determine a set of jobs in a job queue that are to be run in the next epoch and subsequent to the present epoch, wherein the job queue includes a plurality of enqueued jobs;
determine one or more possible paths between a first compute node in a first group and a second compute node in a second group for each of the set of jobs in the job queue;
determine which of the one or more possible paths can be unused in the next epoch and still satisfy the predicted fabric bandwidth demand; and
determine whether each of the global links of the plurality of global links can be disabled as a function of whether that global link is in the one or more possible paths which can be unused.

14. The one or more machine-readable storage media of claim 10, wherein to determine whether any local links of the plurality of local links can be disabled during the next epoch comprises to:
determine a set of jobs in a job queue that are to be run in the next epoch and subsequent to the present epoch, wherein the job queue includes a plurality of enqueued jobs;
determine one or more possible paths between one compute node in a first group and another compute node in a second group for each of the set of jobs in the job queue;
determine which of the one or more possible paths can be unused in the next epoch and still satisfy the predicted fabric bandwidth demand; and
determine whether each of the local links of the plurality of local links can be disabled as a function of whether that local link is in the one or more possible paths which can be unused.

15. The one or more machine-readable storage media of claim 10, wherein to determine whether any of the one or more global links of the plurality of global links can be disabled during the next epoch comprises to determine whether any of the one or more global links of the plurality of global links can be disabled during the next epoch based on one or more quality of service requirements.

16. The one or more machine-readable storage media of claim 10, wherein to determine whether any of the one or more local links of the plurality of local links can be disabled during the next epoch comprises to determine whether any of the one or more local links of the plurality of local links can be disabled during the next epoch based on one or more quality of service requirements.

17. The one or more machine-readable storage media of claim 10, wherein the plurality of instructions further cause the compute device to determine whether any global switches of the plurality of global switches can be disabled during the next epoch as a function of the calculated predicted fabric bandwidth demand and the determined any global links of the plurality of global links which can be disabled during the next epoch.

18. The one or more machine-readable storage media of claim 10, wherein the plurality of instructions further cause the compute device to update one or more routing tables to reflect the disabled one or more global links of the plurality of global links and the disabled one or more local links of the plurality of local links.

19. A compute device for dynamic bandwidth management of an interconnect fabric that includes a plurality of groups, wherein each group of the plurality of groups includes (i) a plurality of compute nodes, (ii) a plurality of local node switches, and (iii) a plurality of global switches, wherein each of the plurality of compute nodes is communicatively coupled to a respective one of the plurality of local node switches of the same group via a corresponding node link of a plurality of node links, wherein each of the plurality of local node switches in each respective group is communicatively coupled to each of the global switches in the same respective group via a corresponding local link of a plurality of local links, and wherein each of the plurality of global switches of each of the plurality of groups is communicatively coupled to other global switches in each of the other of the plurality of groups via a corresponding global link of a plurality of global links, the compute device comprising:
means for calculating a predicted fabric bandwidth demand which is expected to be used by the interconnect fabric in a next epoch and subsequent to a present epoch;
means for determining whether any one or more global links of the plurality of global links can be disabled during the next epoch as a function of the calculated predicted fabric bandwidth demand;
means for determining whether any local links of the plurality of local links can be disabled during the next epoch as a function of the calculated predicted fabric bandwidth demand;
circuitry for disabling, in response to a determination that one or more global links of the plurality of global links can be disabled, the one or more global links of the plurality of global links that can be disabled; and
circuitry for disabling, in response to a determination that one or more local links of the plurality of local links can be disabled, the one or more local links of the plurality of local links that can be disabled.

20. The compute device of claim 19, wherein the means for calculating the predicted fabric bandwidth demand comprises:
means for determining a set of jobs in a job queue that are to be run in the next epoch and subsequent to the present epoch, wherein the job queue includes a plurality of enqueued jobs;
means for determining a predicted bandwidth demand for each of the set of enqueued jobs; and
means for calculating the predicted fabric bandwidth demand as a function of a sum of the predicted bandwidth demand for each job.

21. The compute device of claim 19, wherein the means for calculating the predicted fabric bandwidth demand comprises means for calculating the predicted fabric bandwidth demand as an exponential moving average based on past fabric bandwidth usage over one or more previous epochs.

22. The compute device of claim 19, wherein the means for determining whether any global links of the plurality of global links can be disabled during the next epoch comprises:
means for determining a set of jobs in a job queue that are to be run in the next epoch and subsequent to the present epoch, wherein the job queue includes a plurality of enqueued jobs;
means for determining one or more possible paths between a first compute node in a first group and a second compute node in a second group for each of the set of jobs in the job queue;
means for determining which of the one or more possible paths can be unused in the next epoch and still satisfy the predicted fabric bandwidth demand; and
means for determining whether each of the global links of the plurality of global links can be disabled as a function of whether that global link is in the one or more possible paths which can be unused.

23. The compute device of claim 19, wherein the means for determining whether any local links of the plurality of local links can be disabled during the next epoch comprises:
means for determining a set of jobs in a job queue that are to be run in the next epoch and subsequent to the present epoch, wherein the job queue includes a plurality of enqueued jobs;
means for determining one or more possible paths between one compute node in a first group and another compute node in a second group for each of the set of jobs in the job queue;
means for determining which of the one or more possible paths can be unused in the next epoch and still satisfy the predicted fabric bandwidth demand; and
means for determining whether each of the local links of the plurality of local links can be disabled as a function of whether that local link is in the one or more possible paths which can be unused.

24. The compute device of claim 19, wherein the compute device further comprises means for determining whether any global switches of the plurality of global switches can be disabled during the next epoch as a function of the calculated predicted fabric bandwidth demand and the determined any global links of the plurality of global links which can be disabled during the next epoch.

25. The compute device of claim 19, wherein the compute device further comprises means for updating one or more routing tables to reflect the disabled one or more global links of the plurality of global links and the disabled one or more local links of the plurality of local links.
